(19) United States
(12) Patent Application Publication
(10) Pub. No.: US 2022/0247449 A1
(43) Pub. Date: Aug. 4, 2022

(54) Beam-Time Hopping Modulation System and Method

(71) Applicant: Huawei Technologies Co., Ltd., Shenzhen (CN)

(72) Inventors: Arkady Molev-Shteiman, Basking Ridge, NJ (US); Xiao-Feng Qi, Westfield, NJ (US)

(21) Appl. No.: 17/660,475

(22) Filed: Apr. 25, 2022

Related U.S. Application Data
(63) Continuation of application No. PCT/US2020/055249, filed on Oct. 12, 2020.

(51) Int. Cl. H04B 1/7093; H04B 1/04; H04B 7/0426; H04L 5/00

(52) U.S. Cl. CPC H04B 1/7093; H04B 1/0458; H04B 2001/0408; H04L 5/0023; H04B 2001/70935; H04B 7/043

(57) ABSTRACT

A system includes an analog front-end configured to process a signal to obtain amplified beams, the signal being formed by pulses of a plurality of beams, pulses of each of the plurality of beams being generated according to a time-hopping modulation scheme, a plurality of radars coupled to the analog front-end, the plurality of radars configured to transmit each of the amplified beams at a different angle, and to receive reflections of the transmitted beams, and a plurality of correlators coupled to the plurality of radars through the analog front-end, the plurality of correlators being configured to process the reflections of the transmitted beams to obtain proximity measurements.

### CROSS REFERENCE TO RELATED APPLICATIONS

This application is a continuation of Application No. PCT/US2020/055249, entitled “Beam-time Hopping Modulation System and Method,” filed on Oct. 12, 2020, which application is hereby incorporated herein by reference.

### TECHNICAL FIELD

The present disclosure relates to a beam-time hopping modulation system, and, in particular embodiments, to a beam-time hopping modulation system for automotive radars.

### BACKGROUND

As technologies further advance, a variety of autonomous (also referred to as “automated”) driving vehicles have become popular. An autonomous driving vehicle is a vehicle capable of detecting environmental conditions and operating with various levels of human control. Autonomous driving vehicles include a variety of sensors such as radars to detect the environmental conditions in the vicinity of the vehicle. An advanced control system processes the detected information to identify objects adjacent to the vehicle. After identifying the objects, the control system identifies a suitable driving path, and generates control instructions based on the driving path.

Automotive radar can be used to determine various parameters of an object adjacent to the autonomous driving vehicle. For example, automotive radar enables determination of the distance and velocity (if applicable) between the object and the autonomous driving vehicle through transmitting a radio frequency signal, receiving a reflected signal, and determining the distance based on a time difference between the time instant of transmitting the signal and the time instant of receiving the reflected signal. The same principles apply in instances where lidar (laser imaging, detection and ranging) is used alone, or in conjunction with, radar.

In some applications, mutual interference between different automotive radars is one of the major challenges in the automotive radar design. There may be two major directions to solve this issue. A first direction is based on vehicle-to-vehicle communication such as inter-vehicle cooperation. However, this solution requires an inter-vehicle communication link Such an inter-vehicle communication link makes the autonomous driving vehicle complex. Furthermore, the inter-vehicle communication link may be not reliable. A second direction is based on various spread spectrum modulation control schemes such as Direct Sequence, Frequency Hopping and the like. The spread spectrum modulation control schemes are able to make signals orthogonal to each other in the frequency domain. As a result of maintaining orthogonality between the signals, the mutual interference between different automotive radars can be eliminated or reduced. However, this optimal orthogonality may not be maintained due to a variety of factors such as the non-linearity in the receiver's analog front-end. For example, the disturbing signal coming from a nearby vehicle may be overwhelmingly stronger than the radar's own reflected signal. This strong interference may saturate the receiver's analog front-end. After the analog front-end has been saturated, the radar's own reflected signal cannot effectively penetrate through the analog front-end. In order to overcome the impact from the strong interference, the autonomous driving vehicle needs a high quality analog front-end with a large dynamic range. The requirement for such a high quality analog front-end makes the radar of the autonomous driving vehicle complex and expensive.

In the applications requiring an autonomous driving vehicle having a reliable and inexpensive automotive radar system, it is desirable to have a radar control scheme capable of preventing harmful interference from impacting the reflected signals, thereby reliably detecting objects in the vicinity of the autonomous driving vehicle, particularly important in situations where the objects and the autonomous vehicle are moving relative to one another.

### SUMMARY

These and other problems are generally solved or circumvented, and technical advantages are generally achieved, by preferred embodiments of the present disclosure that provide a beam-time hopping modulation system for time and position-sensitive applications such as those encountered with autonomous vehicles.

In accordance with an embodiment, a system includes an analog front-end configured to process a signal to obtain amplified beams. The signal is formed by pulses of a plurality of beams Pulses of each of the plurality of beams are generated according to a time-hopping modulation scheme. The system further includes a plurality of radars coupled to the analog front-end. The plurality of radars is configured to transmit each of the amplified beams at a different angle, and to receive reflections of the transmitted beams. The system further includes a plurality of correlators coupled to the plurality of radars through the analog front-end. The plurality of correlators is configured to process the reflections of the transmitted beams to obtain proximity measurements.

The system further comprises a fast Fourier transform (FFT) engine coupled between the analog front-end and the plurality of correlators. The FFT engine is configured to process the reflections of the transmitted beams, and retrieve signals for the plurality of correlators.

The FFT engine is configured to generate a plurality of signals. Each of the plurality of signals is fed into a corresponding correlator. Proximity measurement information for each angle is derived based on an output signal of the corresponding correlator.

The system further comprises a beamformer coupled to the analog front-end and a pseudo-noise (PN) angle generator coupled to the beamformer. The beamformer is configured to generate the plurality of beams The PN angle generator is configured to specify pulse positioning over time for each beam.

The PN angle generator is configured to combine the time-hopping modulation scheme with a beam-hopping modulation scheme.

Under the time-hopping modulation scheme, each beam of the plurality of beams is a discontinuous signal in a time domain Under a combination of the time-hopping modulation scheme and the beam-hopping modulation scheme, signals from the plurality of beams form the signal processed by the analog front-end, wherein the signal processed by the analog front-end is a continuous or substantially continuous signal.

Each beam of the plurality of beams comprises a plurality of pulses at pseudo-random time slots. Under a combination of the time-hopping modulation scheme and the beam-hopping modulation scheme, the pulses from the plurality of beams are combined to form the continuous or substantially continuous signal.

The system further comprises a plurality of peak-finding units coupled to the plurality of correlators. Each of the plurality of peak-finding units is configured to measure a distance between an object and the system based on a delay between a reflection of a transmitted beam and the transmitted beam.

In accordance with another embodiment, a method includes transmitting a plurality of beams by a plurality of radars. Each of the plurality of beams includes a plurality of pulses and is transmitted at a different angle. The method further includes specifying, by a pseudo-noise (PN) angle generator, pulse positioning over time of a beam of the plurality of beams through applying a time-hopping control scheme to the beam, and applying a combination of the time-hopping control scheme and a beam-hopping control scheme in the PN angle generator to pulses of the plurality of beams, where as a result of applying the combination of the time-hopping control scheme and the beam-hopping control scheme, the pulses of the plurality of beams form a continuous or substantially continuous signal.

The method further comprises configuring the PN generator to generate a PN code based on the combination of the time-hopping control scheme and the beam-hopping control scheme, and coding the plurality of beams based on the PN code.

The method further comprises receiving reflections of the transmitted beams, and decoding the reflections of the transmitted beams based on the PN code.

The method further comprises receiving reflections of the transmitted beams, and applying an FFT algorithm to the reflections of the transmitted beams As a result of applying the FFT algorithm, a received signal for each angle is retrieved.

The method further comprises providing a plurality of correlators configured to receive signals for respective angles, and processing the signals for the respective angles through the plurality of correlators, wherein the signals for the respective angles are orthogonal to each other.

Applying the time-hopping control scheme comprises generating a PN code, and selecting a time slot for a pulse of the beam in a time frame based on the PN code.

By applying the combination of the time-hopping control scheme and the beam-hopping control scheme, the pulses of the plurality of beams are interleaved to form the continuous or substantially continuous signal.

The method further comprises processing the continuous or substantially continuous signal using an analog front-end coupled to the plurality of radars.

In accordance with yet another embodiment, a method includes transmitting, by a plurality of radars, a plurality of beams in a plurality of predetermined directions. Each beam includes a plurality of pulses generated in a beamformer. The method further includes selecting time slots of the plurality of pulses according to a time-hopping control scheme, and interleaving pulses of the plurality of beams to form a continuous or substantially continuous signal by generating the pulses of the plurality of beams according to a combination of the time-hopping control scheme and a beam-hopping control scheme, where the combination of the time-hopping control scheme and the beam-hopping control scheme is generated in a pseudo-noise (PN) angle generator coupled to the beamformer.

The method further comprises generating, by the PN angle generator, a PN code based on the combination of the time-hopping control scheme and the beam-hopping control scheme, coding the plurality of beams based on the PN code, processing the plurality of beams using an analog front-end coupled between the beamformer and the plurality of radars to obtain a plurality of beams, transmitting the plurality of beams processed by the analog front-end through the plurality of radars, receiving reflections of the transmitted beams through the plurality of radars, retrieving directional signals from the reflections of the transmitted beams through a fast Fourier transform (FFT) engine coupled to the plurality of radars through the analog front-end, and processing the directional signals through a plurality of correlators coupled to the FFT engine.

The analog front-end is configured to process the continuous or substantially continuous signal.

The method further comprises based on a delay between a reflection and a corresponding transmitted beam, measuring a distance between an object and a system comprising the plurality of radars.

An advantage of an embodiment of the present disclosure is achieving accurate and reliable object detection for autonomous driving vehicles.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a beam-time hopping modulation system transmitting a plurality of beams in accordance with various embodiments of the present disclosure;

FIG. 2 illustrates a plurality of beams controlled by the beam-time hopping control scheme in accordance with various embodiments of the present disclosure;

FIG. 3 illustrates a block diagram of a beam-time hopping modulation system in accordance with various embodiments of the present disclosure;

FIG. 4 illustrates a first implementation of a simulation testbed for the beam-time hopping modulation system in accordance with various embodiments of the present disclosure;

FIG. 5(A) and FIG. 5(B) illustrate simulation results from the simulation testbed shown in FIG. 4 in accordance with various embodiments of the present disclosure;

FIG. 6(A) and FIG. 6(B) illustrate the effects of a delay estimation algorithm in accordance with various embodiments of the present disclosure;

FIG. 7 illustrates a second implementation of the simulation testbed for the beam-time hopping modulation system in accordance with various embodiments of the present disclosure;

FIG. 8(A) and FIG. 8(B) illustrate simulation results from the simulation testbed shown in FIG. 7 in accordance with various embodiments of the present disclosure;

FIG. 9 illustrates a flow chart of a method of applying the beam-time hopping control scheme to the system shown in FIG. 3 in accordance with various embodiments of the present disclosure; and

FIG. 10 illustrates a flow chart of another method of applying the beam-time hopping control scheme to the system shown in FIG. 3 in accordance with various embodiments of the present disclosure.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

Methods and systems of the presently preferred embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The present disclosure will be described with respect to preferred embodiments in a specific context, namely a beam-time hopping modulation system for automotive radars. The present disclosure may also be applied, however, to a variety of radar systems such as those operable in two and three-dimensional spaces. Hereinafter, various embodiments will be explained in detail with reference to the accompanying drawings.

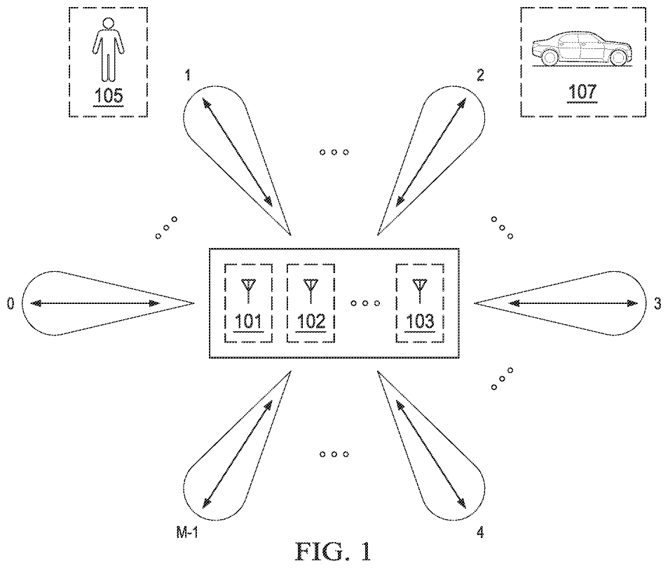

FIG. 1 illustrates a beam-time hopping modulation system transmitting a plurality of beams in accordance with various embodiments of the present disclosure. The beam-time hopping modulation system comprises a plurality of radars 101, 102 and 103. In some embodiments, the plurality of radars may be in an autonomous driving vehicle. The plurality of radars may be employed to detect objects in the vicinity of the autonomous driving vehicle.

As shown in FIG. 1, the plurality of radars 101-103 transmits a plurality of beams, namely beam 0, beam 1, beam 2, and beam M-1. The beams are transmitted in a radial direction with respect to the plurality of radars. In other words, the beams are transmitted to achieve the 360-degree coverage with respect to the plurality of radars. After the beams have been transmitted, the plurality of radars 101-103 may receive a plurality of reflected beams Each reflected beam is associated with a corresponding beam transmitted from the plurality of radars. The reflected beam may indicate an object (e.g., a pedestrian 105 and/or a car 107) in the direction of the corresponding beam. More particularly, if the plurality of radars is surrounded by one or multiple objects, a plurality of reflected beams is generated after some of the beams sent from plurality of radars reflect off the multiple objects.

In operation, the plurality of radars 101- 103 is employed to transmit the plurality of beams. Each of the plurality of beams comprises a plurality of pulses and is transmitted at a different angle. The beams transmitted from the plurality of radars 101-103 are modulated by a control scheme modified from the direct sequence spread spectrum technology.

The direct sequence spread spectrum technology is described below with respect to a system where the plurality of radars forms a planar linear array of M=M_{V}×M_{H} antennas. M_{V} is the number of horizontal antennas rows, and M_{H} is the number of vertical antennas columns. Two adjacent antennas are placed at a spacing of half a wavelength.

In some embodiments, there may be a plurality of radar systems. Each radar system may be associated with a user. In other words, each user may have at least one planar linear array of antennas. The antennas of the planar linear array transmit a plurality of direct sequence spread spectrum signals. In some embodiments, the direct sequence spread spectrum signal transmitted by antenna m of array k (user k) can be expressed by the following equation:

$$T {X}_{k} ( m , t ) = {\sum }_{n = 0}^{{N}_{F} - 1} s t r ( m , α ( n ) ) \cdot {c}_{k} ( n ) \cdot Π ( ( t - n \cdot {T}_{C} ) / {T}_{C} ) \qquad ( 1 )$$

where str(m, α(n)) is the steering function of antenna m in direction α=[α_{V}, α_{H}]. α_{V} is the vertical angel, and α_{H} is the horizontal angle. cₖ (n) is a pseudo-noise (PN) code sequence for the chip number n, and α(n) is the angle sequence. T_{C} is the chip duration, and N_{F} is the number of chips in a radar update frame. The function Π(ₜ) can be given by the following equation:

$$Π ( t ) = \{ \begin{matrix}1 & if ( 0 \leq t < 1 ) \\ 0 & else\end{matrix} \qquad ( 2 )$$

The steering function str(m, α(n)) can be given by the following equation:

$$s t r ( m , α ( n ) ) = exp ( \sqrt{- 1} \cdot π \cdot ( {m}_{V} ( m ) \cdot sin ( α ( n ) ) + {m}_{H} ( m ) \cdot sin ( α ( n ) ) ) ) \qquad ( 3 )$$

The vertical and horizontal indexes can be expressed by the following equation:

$${m}_{V} ( m ) = mod ( m , {M}_{V} ) , {m}_{V} ( m ) = fix ( m / {M}_{V} ) \qquad ( 4 )$$

where mod( ) denotes the modulo operation, and fix( ) denotes the integer part operation.

The PN code of each chip can be expressed by the following equation:

$${c}_{k} ( n ) = ( \pm 1 \pm \sqrt{- 1} ) / \sqrt{2} \qquad ( 5 )$$

A set of M orthogonal directions may exist. The set of M orthogonal directions can be expressed by the following equation:

$$\overline{α} ( q ) = [ {\overline{α}}_{V} ( q ) , {\overline{α}}_{H} ( q ) ] q = 0 , 1 , … , M - 1 \qquad ( 6 )$$

In Equation (6), q is an index of the angle α̅. α̅_{V}(q) and α̅_{H}(q) can be expressed by the following equation:

$${\overline{α}}_{V} ( q ) = asin ( {m}_{V} ( q ) / {M}_{V} ) , {\overline{α}}_{H} ( q ) = asin ( {m}_{H} ( q ) / {M}_{H} ) \qquad ( 7 )$$

The orthogonal directions in Equation (6) can satisfy the following equation:

$$\frac{1}{M} \cdot {\sum }_{{m}_{H} = 0}^{M - 1} s t {r ( m , \overline{α} ( {q}_{1} ) )}^{*} \cdot str ( m , \overline{α} ( {q}_{2} ) ) = \{ \begin{matrix}1 & if ( {q}_{1} = {q}_{2} ) \\ 0 & else\end{matrix} \qquad ( 8 )$$

In Equation (8), ( )* denotes a conjugate operation. All other directions may be presented as a linear combination of the orthogonal directions of Equation (6).

All elements of angle sequence α(n) belong to a set of M orthogonal directions in equal proportion. This relationship can be expressed by the following equation:

$${\sum }_{n = 0}^{{N}_{F} - 1} ( \overline{α} ( q ) == α ( n ) ) = {N}_{S F} q = 0 , 1 , … M - 1 \qquad ( 9 )$$

where N_{SF}=N_{F}/M, and depending on whether the statement is correct, the following equation can be satisfied:

$$( Statement ) = \{ \begin{matrix}1 & if Statement is correct \\ 0 & else\end{matrix} \qquad ( 10 )$$

The transmitted signal that is sent by the array to an orthogonal direction α̅(q) can be expressed by the following equation:

$${TX}_{k} ( \overline{α} ( q ) , t ) = \frac{1}{M} \cdot {\sum }_{{m}_{H} = 0}^{M - 1} s t {r ( m , \overline{α} ( q ) )}^{*} \cdot {TX}_{k} ( m , t ) \qquad ( 11 )$$

From Equations (1) and (8), the transmitted signal can be expressed by the following equation:

$${TX}_{k} ( \overline{α} ( q ) , t ) = {\sum }_{n = 0}^{{N}_{F} - 1} {c}_{k} ( q , n ) \cdot Π ( ( t - n \cdot {T}_{C} ) / {T}_{C} ) \qquad ( 12 )$$

where cₖ(q,n) is the PN code that is sent to the direction α̅(q), which can be expressed by the following equation:

$${c}_{k} ( q , n ) = ( \overline{α} ( q ) = α ( n ) ) \cdot {c}_{k} ( n ) \qquad ( 13 )$$

In some embodiments, the PN codes of the radars and their respective directions are orthogonal. The following equation can be satisfied:

$$\frac{1}{{N}_{SF}} \cdot {\sum }_{n = 0}^{{N}_{SF - 1}} {{c}_{k 1} ( q 1 , n )}^{*} \cdot {c}_{k 2} ( q 2 , n - τ ) ≅ \{ \begin{matrix}1 & if ( ( {k}_{1} == {q}_{2} ) ⋀ ( {k}_{1} = = {q}_{2} ) ⋀ ( τ == 0 ) ) \\ 0 & else\end{matrix} \qquad ( 14 )$$

where the delay τ satisfies the following equation:

$$max ( τ ) = {N}_{S F} \qquad ( 15 )$$

The random code of radar k at angle q can be given by the following equation:

$$c o d {e}_{k} ( q , t ) = {c}_{k} ( q , n ) \cdot Π ( ( t - n \cdot {T}_{C} ) / {T}_{C} ) \qquad ( 16 )$$

Equations (1)-(16) above are based on the transmitted signals. The following equations are employed to show the characteristics of the received signals.

First, for simplicity, the Doppler Effect is not considered, and both the radar and reflective surfaces are static. Then, the received signal at antenna m can be expressed by the following equation:

$${RX}_{k} ( m , t ) = {S}_{k} ( m , t ) + {I}_{k} ( m , t ) + {N}_{k} ( m , t ) + {W}_{k} ( m , t ) \qquad ( 17 )$$

where Sₖ (m,t) is the desired component of the received signal. Iₖ(m,t) is the interference. Nₖ(m,t) is the thermal noise. Wₖ(m,t) is the receiver non-linear distortion (NLD).

The desired component of the received signal can be expressed by the following equation:

$${S}_{k} ( m , t ) = ( \frac{1}{M} ) \times {\sum }_{q = 0}^{M - 1} s t r ( m , \overline{α} ( q ) ) \cdot {g}_{k} ( \overline{α} ( q ) ) \cdot {TK}_{k} ( \overline{α} ( q ) , t - {τ}_{k} ( \overline{α} ( q ) ) ) \qquad ( 18 )$$

The interference signal can be expressed by the following equation:

$${I}_{k} ( m , t ) = ( \frac{1}{M} ) \times {\sum }_{{k 0 = 0}_{k 0 \neq k}}^{K - 1} {\sum }_{q = 0}^{M - 1} s t r ( m , \overline{α} ( q ) ) \cdot {g}_{k 0} ( \overline{α} ( q ) ) \cdot {TK}_{k 0} ( \overline{α} ( q ) , t - {τ}_{k 0} ( \overline{α} ( q ) ) ) \qquad ( 19 )$$

where K is the total number of radars.

The NLD can be expressed by the following equation:

$${W}_{k} ( m , t ) = F ( {S}_{k} ( m , t ) + {I}_{k} ( m , t ) + {N}_{k} ( m , t ) ) \qquad ( 20 )$$

where F(x)=f(x)−x, and f(x) is the receiver transfer function. If interference power is very high and the receiver transfer function is not sufficiently linear, then NLD power may explosively grow.

From Equation (14), the received signal Sₖ(m, t) is orthogonal to the interference Iₖ(m,t).

However, the received signal is not orthogonal to NLD Wₖ(m,t), which is generated by non-linear distortions. As a result, the distortions may generate another interference if the receiver transfer function is not sufficiently linear.

The following equations are related to the reflection measurement operation of the plurality of radars. The goal of the radars is to estimate the complex amplitude ĝₖ(q) and delay \hat{τ}ₖ(q) of the reflected path for each direction. This operation can be expressed by the following equation:

$${\hat{τ}}_{k} ( q ) = {arg max}_{τ} ( \vert {cor}_{k} ( q , τ ) \vert ) , {\hat{g}}_{k} ( q ) = c o {r}_{k} ( q , {\hat{τ}}_{k} ( q ) ) \qquad ( 21 )$$

where the correlation function can be expressed as:

$$c o {r}_{k} ( q , τ ) = \frac{1}{{N}_{F} \cdot {T}_{C}} \cdot {\int }_{t = 0}^{{N}_{F} \cdot {T}_{C}} {{code}_{k} ( q , t - τ )}^{*} \cdot {RX}_{k} ( \overline{α} ( q ) , t ) \cdot dt \qquad ( 22 )$$

where RXₖ(α̅(q),t) is the projection of the received signal in the antenna domain having an angle α̅(q)

$$R {X}_{k} ( \overline{α} ( q ) , t ) = \frac{1}{M} \cdot {\sum }_{q = 0}^{M - 1} s t {r ( m , \overline{α} ( q ) )}^{*} \cdot {RX}_{k} ( m , t ) \qquad ( 23 )$$

From Equations (22), (17), (18), (19), (12), (8) and (14), the correlation function can be expressed as:

$$c o {r}_{k} ( q , r ) = \frac{1}{{N}_{F} \cdot {T}_{C}} \cdot {\int }_{t = 0}^{{N}_{F} \cdot {T}_{C}} c o d {e}_{k} ( q , t - τ ) \cdot {S}_{k} ( \overline{α} ( q ) , t ) \cdot dt + \frac{1}{{N}_{F} \cdot {T}_{C}} \cdot {\int }_{t = 0}^{{N}_{F} \cdot {T}_{C}} c o d {e}_{k} ( q , t - τ ) \cdot {N}_{k} ( \overline{α} ( q ) , t ) \cdot dt + \frac{1}{{N}_{F} \cdot {T}_{C}} \cdot {\int }_{t = 0}^{{N}_{F} \cdot {T}_{C}} c o d {e}_{k} ( q , t - τ ) \cdot {WS}_{k} ( \overline{α} ( q ) , t ) \cdot dt \qquad ( 24 )$$

where Sₖ(α̅(q),t), Nₖ(α̅(q),t) are the projection of the desired component of the received signal, thermal noise and NLD in an antenna domain having the angle α̅(q), respectively, which can be expressed by the following equations:

$$\begin{matrix}{S}_{k} ( \overline{α} ( q ) , t ) = \frac{1}{M} \cdot {\sum }_{q = 0}^{M - 1} {str ( m , \overline{α} ( q ) )}^{*} \cdot {S}_{k} ( m , t ) & ( 25 ) \\ {N}_{k} ( \overline{α} ( q ) , t ) = \frac{1}{M} \cdot {\sum }_{q = 0}^{M - 1} s t {r ( m , \overline{α} ( q ) )}^{*} \cdot {N}_{k} ( m , t ) & ( 26 ) \\ {W}_{k} ( \overline{α} ( q ) , t ) = \frac{1}{M} \cdot {\sum }_{q = 0}^{M - 1} s t {r ( m , \overline{α} ( q ) )}^{*} \cdot {W}_{k} ( m , t ) & ( 27 )\end{matrix}$$

From Equation (24), the interference itself has no or minimal impact on the radar estimation. However, in case when the receiver transfer function is not sufficiently linear, the NLD may cause interference as shown by Equation (27), which may significantly disturb the accuracy of the reflection measurement.

In order to overcome the disadvantage indicated by Equation (27), a time-hopping control scheme can be applied to the beams The time-hopping control scheme keeps orthogonality even in presence of non-linear distortions because interferers only saturate the analog front-end for a short period of time. As such, the time-hopping control scheme is able to prevent non-linear distortions from having an impact on the reflection measurement. The time-hopping control scheme, however, generates a discontinuous signal. The peak energy of this discontinuous signal is much larger than the average energy. In order to handle this discontinuous signal, the analog front-end may have a wide dynamic range.

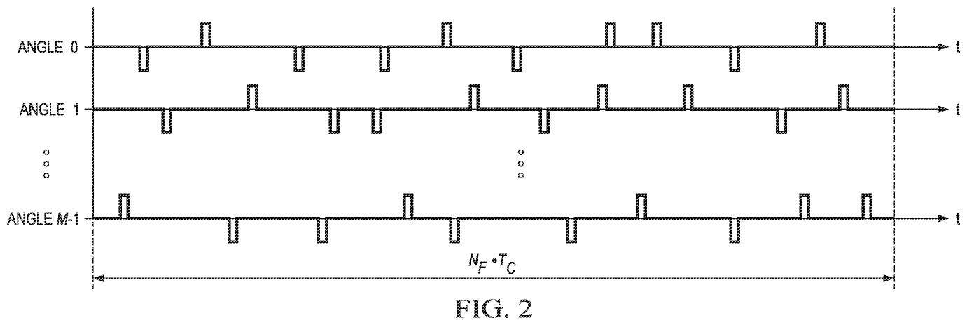

In this disclosure, a combination of the time-hopping control scheme and a beam-hopping control scheme is applied to pulses of the plurality of beams The beam-hopping control scheme is able to control the radar direction through a pseudo-random modulation. More particularly, the beam-hopping control scheme is configured such that the discontinuous signals of the plurality of beams function as a continuous or substantially continuous waveform processed by an analog front-end. In other words, in each direction, the signal of each beam is generated based on the time-hopping control scheme, and the waveform of the signal is a discontinuous waveform. By applying the combination of the time-hopping control scheme and the beam-hopping control scheme, the pulses of the plurality of beams form a continuous or substantially continuous signal processed by the analog front-end. More particularly, the pulses of the plurality of beams are interleaved to form the continuous or substantially continuous signal. Throughout the description, the continuous or substantially continuous signal may be alternatively referred to as a continuous signal. The combination of the time-hopping control scheme and the beam-hopping control scheme is referred to as a beam-time hopping control scheme. The plurality of beams controlled by the beam-time hopping control scheme is shown in FIG. 2.

Throughout the description, the time-hopping control scheme may be alternatively referred to as a time-hopping modulation scheme. The beam-hopping control scheme may be alternatively referred to as a beam-hopping modulation scheme. The beam-time hopping control scheme may be alternatively referred to as an angle-time hopping control scheme.

FIG. 2 illustrates a plurality of beams controlled by the beam-time hopping control scheme in accordance with various embodiments of the present disclosure. FIG. 2 illustrates M beams A plurality of radars is configured to transmit these M beams Each beam of the plurality of beams is transmitted at a different angle. For example, a first beam is transmitted at Angle 0. A second beam is transmitted at Angle 1. The last beam is transmitted at Angle M-1. All the angles shown in FIG. 2 are predetermined. Depending on different applications and design needs, all the angles may vary accordingly. T_{c} is the chip duration. N_{F} is the number of chips for each angle.

FIG. 2 illustrates M waveforms associated with the M beams Each waveform is generated based on the time hopping modulation scheme. The number k waveform of the M waveforms can be expressed by the following equation:

$${S}_{k} ( t ) = {Σ}_{n = 0}^{N - 1} {c}_{k} ( n ) \cdot Π ( \frac{1 - ( n \cdot {N}_{F} + {d}_{k} ( n ) ) \cdot {T}_{CHIP}}{{T}_{CHIP}} ) \qquad ( 28 )$$

In Equation (28), T_{CHIP} is the duration of a chip. Cₖ(n) is the code pseudo-random sequence of the number k waveform, and dₖ(n) is the delay pseudo-random sequence of the number k waveform. The function Π(t) can be expressed by the following equation:

$$\prod ( t ) = \{ \begin{matrix}1 & if ( 0.5 \leq t < 0.5 ) \\ 0 & else\end{matrix} \qquad ( 29 )$$

As shown in FIG. 2, each beam of the plurality of beams comprises a stream of pseudo-random pulses. In other words, each beam of the plurality of beams comprises a plurality of pulses at pseudo-random time slots. In some embodiments, the pseudo-random pulses are modulated by the time-hopping modulation scheme. Under the time-hopping modulation scheme, each beam of the plurality of beams is a discontinuous signal in the time domain.

One advantageous feature of having the time-hopping modulation scheme is that the interference only has a minimum impact on the beams. In particular, even a strong interferer that saturates the analog front-end can only destroy a small portion of the received chips. The remaining chips are sufficient to provide an accurate estimation of the delay of the reflected signal.

A combination of the time-hopping modulation scheme and the beam-hopping modulation scheme is applied to the plurality of beams shown in FIG. 2. In particular, the beam-hopping modulation scheme configures the pulses from the plurality of beams to be interleaved so as to form a continuous signal fed into the analog front-end.

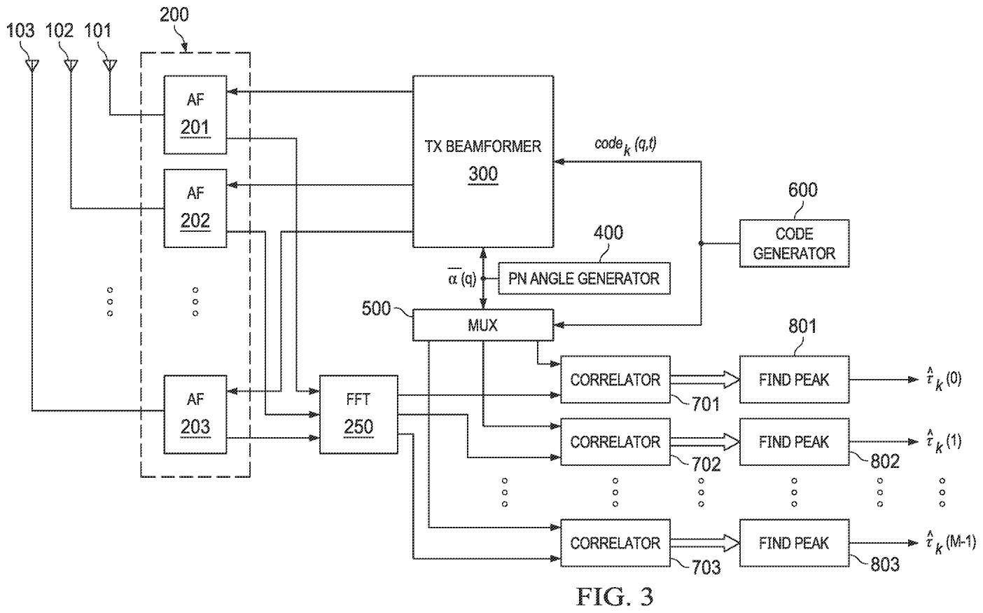

FIG. 3 illustrates a block diagram of a beam-time hopping modulation system in accordance with various embodiments of the present disclosure. The beam-time hopping modulation system comprises a code generator 600, a pseudo-noise (PN) angle generator 400, a beamformer 300, analog front-ends 201-203, and a plurality of radars 101-103. The beam-time hopping modulation system further comprises a fast Fourier transform (FFT) engine 250, a plurality of correlators 701-703, a multiplexer 500, and a plurality of peak-finding units 801-803. Throughout the description, the analog front-ends 201-203 may be collectively referred to as analog front-end 200.

The code generator 600 is employed to generate a random code. The random code comprises a sequence of “1” and “−1” arranged in a random manner Referring back to FIG. 2, each beam of the plurality of beams comprises a stream of pseudo-random pulses. The pseudo-random pulses comprise both positive pulses and negative pulses. The polarity of each pulse is determined by the random code generated by the code generator 600.

The PN angle generator 400 is configured to generate a PN code for specifying pulse positioning over time for each beam. The PN angle generator 400 is configured to combine a time-hopping modulation scheme with a beam-hopping modulation scheme. By selecting a time slot for a pulse of the beam in a time frame based on the PN code, signals from the plurality of beams form the continuous signal.

As shown in FIG. 3, both the random code from the code generator 600 and the PN code from the PN angle generator 400 are fed into the beamformer 300. Based on these two codes, the beamformer 300 is configured to generate the plurality of beams fed into the analog front-end 200. The analog front-end 200 may comprise a plurality of circuits such as operational amplifiers, filters, sensors, receivers and the like. The analog front-end 200 functions as an interface between the beamformer 300 and the plurality of radars 101-103.

It should be noted that, under the time-hopping modulation scheme, each beam of the plurality of beams is a discontinuous signal in the time domain Under a combination of the time-hopping modulation scheme and the beam-hopping modulation scheme, signals from the plurality of beams are combined by the beam-hopping modulation scheme to form the continuous signal processed by the analog front-end 200.

As shown in FIG. 3, the analog front-end 200 is coupled to the plurality of radars 101-103, respectively. The analog front-end 200 is configured to process the continuous signal to obtain amplified beams The plurality of radars 101-103 transmits each of the amplified beams at a different angle. Furthermore, the plurality of radars 101-103 is configured to receive a plurality of beams reflected by an object (e.g., the pedestrian 105 shown in FIG. 1) in the path of the beams By analyzing the reflected beams, a distance between the plurality of radars and the object can be measured accordingly. Throughout the description, the reflected beams may be alternatively referred to as reflections of the transmitted beams

The analog front-end 200 receives the reflected beams through the plurality of radars 101-103. The analog front-end 200 feeds the reflected beams into the FFT engine 250. The plurality of reflected beams is processed by an FFT engine. More particularly, a suitable FFT algorithm is applied to the plurality of reflected beams. As a result of applying the FFT algorithm, the FFT engine generates a plurality of directional signals. Each of the directional signals represents a reflected signal for a corresponding predetermined direction. Through processing the plurality of reflected beams, the FFT engine 250 retrieves signals for the plurality of correlators 701-703.

The beam-time hopping modulation scheme optimally provides simultaneous, or substantially simultaneous, processing of all M orthogonal beams in parallel. The FFT engine 250 implements parallel beamforming with computation complexity only log₂ (M) times larger than the complexity of a single beamformer.

The plurality of correlators 701-703 is configured to receive outputs of the FFT engine 250. As shown in FIG. 3, the outputs of the code generator 600 and the PN angle generator 400 are also fed into the correlators 701-703 through the multiplexer 500. The outputs of the code generator 600 and the PN angle generator 400 are used to decode the reflected signals at the correlators 701-703.

As shown in FIG. 3, a plurality of correlators (M correlators) is configured to receive signals for respective angles. The signals for the respective angles are processed in parallel through the plurality of correlators 701-703 for obtaining proximity measurements. The signals for the respective angles are orthogonal to each other.

The M correlators (e.g., correlators 701-703) shown in FIG. 3 are implemented based on the correlation function shown in Equation (22) above.

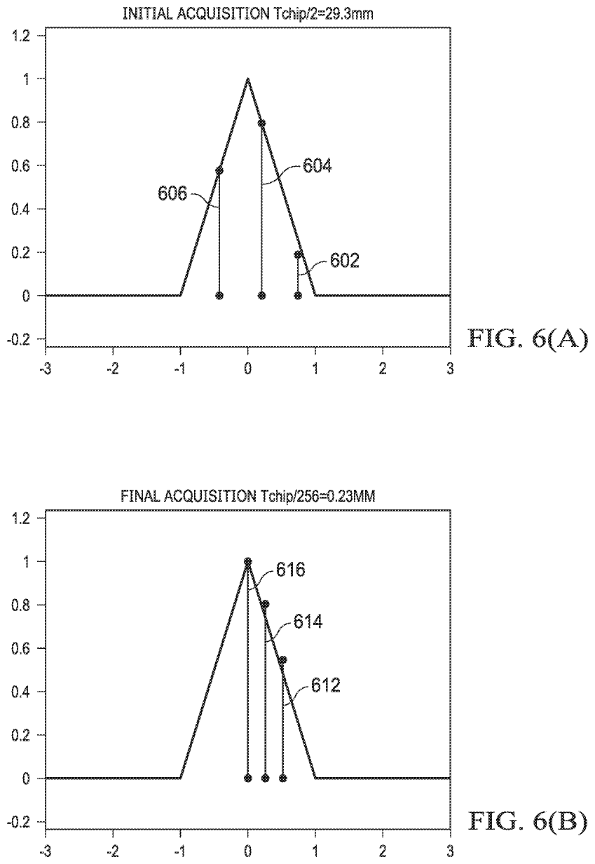

The outputs of the correlators 701-703 are fed into the respective peak-finding units 801-803. In each peak-finding unit, the delay for each angle is found based on Equation (21). The peak-finding unit is configured to measure a distance between an object and the system based on a delay between a reflection of a transmitted beam and the transmitted beam. The peak-finding process will be described in detail with respect to FIG. 6.

Spatial positioning information for each angle is derived based on an output signal of the corresponding peak-finding unit. The delay includes the spatial positioning information. The distance between the object and the plurality of radars can be expressed by the following equation:

$$D = c \cdot {\hat{τ}}_{k} ( q ) / 2 \qquad ( 30 )$$

In Equation (30), D is the distance between the object and the plurality of radars. \hat{τ}ₖ(q) is the delay at one particular direction, and c is the speed of light.

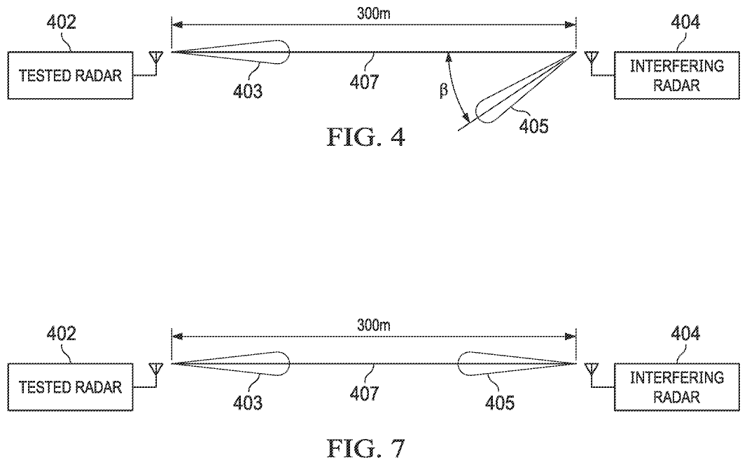

FIG. 4 illustrates a first implementation of a simulation testbed for the beam-time hopping modulation system in accordance with various embodiments of the present disclosure. The testbed comprises a tested radar system 402 and an interfering radar system 404. The interfering radar system 404 also serves as reflector. In some embodiments, both radar systems are equipped by a linear planar array of M_{Y}×M_{H}=32×32 antennas.

As shown in FIG. 4, the distance between these two radar systems is about 300 meters. In the simulation, both the direct sequence spread spectrum control scheme and the beam-time hopping control scheme have been simulated with the following parameters:

$$The chip rate \text{:} {F}_{CHIP} = 5.12 GHz \\ The update rate \text{:} {F}_{UPDATE} = 50 Hz \qquad ( 31 )$$

Based upon the parameters shown in Equation (31), the number of chips per angle can be expressed by the following equation:

$${N}_{S F} = {F}_{UPDATE} / ( {M}_{V} \cdot {M}_{H} \cdot {F}_{CHIP} ) = 100 , 000 \qquad ( 32 )$$

In the simulation, to generate the pseudo random code cₖ (n) and the pseudo random angle sequence α(n), both radar systems use the standard Matlab random number generator with different seeds. The two radar systems simultaneously send scanning signals. As shown in FIG. 4, the scanning signal 403 from the tested radar system 402 is sent along the line 407. The scanning signal 405 from the interfering radar system 404 extends away from the line 407 by an angle β. In order to compare the direct sequence spread spectrum control scheme and the beam-time hopping control scheme, the angle may vary in the simulation. The signal that arrives to the tested radar system comprises both the reflected signal and the interfering signal.

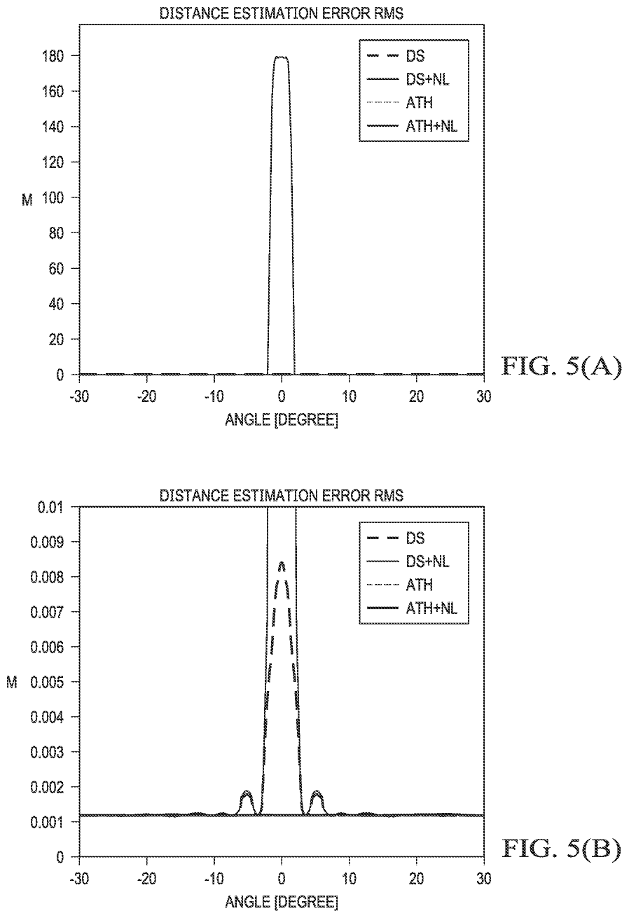

FIG. 5(A) and FIG. 5(B) illustrate simulation results from the simulation testbed shown in FIG. 4 in accordance with various embodiments of the present disclosure. The curves in FIG. 5(A) are simulation results from the testbed when different control schemes and operation conditions are applied to the testbed. The vertical axis represents the distance estimation error. The unit of the vertical axis is meter. The horizontal axis represents the angle β. The unit of the horizontal axis is degree.

The testbed is tested under four different testing conditions. In a first testing condition, the direct sequence spread spectrum control scheme is applied to the testbed. The first testing condition is denoted as DS as shown in FIG. 5(A) and FIG. 5(B). In a second testing condition, the direct sequence spread spectrum control scheme is applied to the testbed in presence of non-linear distortions. The second testing condition is denoted as DS+NL as shown in FIG. 5(A) and FIG. 5(B). In a third testing condition, the beam-time hopping control scheme is applied to the testbed. The beam-time hopping control scheme is also referred to as an angle-time hopping (ATH) control scheme. The third testing condition is denoted as ATH as shown in FIG. 5(A) and FIG. 5(B). In a fourth testing condition, the beam-time hopping control scheme is applied to the testbed in presence of non-linear distortions. The fourth testing condition is denoted as ATH+NL as shown in FIG. 5(A) and FIG. 5(B).

As shown in FIG. 5(A), the distance estimation error is almost equal to zero when the angle β is not equal to zero. When the angle _{R} is near zero, under the second testing condition, the distance estimation error is up to 180 meters. FIG. 5(B) is a detailed view showing the simulation results at an enlarged scale. The detailed view shows under the first testing condition, the distance estimation error is about 0.0085 meters when the angle β is around zero. Under the third and fourth testing conditions, the distance estimation error is about 0.001 meters. The simulation results shown in FIG. 5(A) and FIG. 5(B) indicate the beam-time hopping control scheme can improve the accuracy of the distance measurement.

FIGS. 6(A) and 6(B) illustrate the effects of a delay estimation algorithm in accordance with various embodiments of the present disclosure. The vertical axis of FIGS. (A) and 6 (B) represents the value of the correlation function shown in Equation (22). The horizontal axis represents the delay, which is

$$\frac{( τ - {τ}_{k , q} )}{{T}_{C}} \cdot {τ}_{k , q}$$

is the delay of the reflected signal. T_{C} is the chip duration. FIG. 6(A) shows an initial acquisition of the delay. FIG. 6(B) shows a final acquisition of the delay. As shown in FIG. 6(A) and FIG. 6(B), the value of the correlation function is triangular in shape within two intervals (|τ−τ_{k,q}|≤T_{C}). A first interval is from −1 to 0, which is one TC. A second interval is from 0 to 1, which is the other interval. The value of the correlation function reaches its maximum when (τ−τ_{k,q})=0.

Outside of these two intervals, the value of the correlation function is approximately equal to zero. The test receiver estimates the distance to reflector by finding the maximum of the correlation function according to Equation (21) above. At the beginning, the correlation is estimated with a step equal to Tchip/2. A product of Tchip times the speed of light is equal to 58.6 mm. One half of this is about 29.3 mm as shown in FIG. 6(A). An iterative search is employed to find the peak of the correlation function. A first step 602, a second step 604 and a third step 606 are used to find the peak. With this relatively large step, the accuracy is not good. The peak value of the correlation function cannot be found. After the initial acquisition, the search is iteratively repeated around the correlation maximum. After a predetermined number of iterations, the final acquisition is employed to find the correlation maximum. As shown in FIG. 6(B), the step of the final acquisition is equal to Tchip/256, which is about 0.23 mm as shown in FIG. 6(B). In the final acquisition, a first step 612, a second step 614 and a third step 616 are used to find the peak value. As shown in FIG. 6(B), at the third step, the peak value of the correlation function can be obtained.

FIG. 7 illustrates a second implementation of the simulation testbed for the beam-time hopping modulation system in accordance with various embodiments of the present disclosure. The second implementation is similar to the first implementation shown in FIG. 4 except that the two radar systems simultaneously send scanning signals toward each other. Both tested radar system 402 and the interfering radar system 404 send the scanning signals along the line 407, with reflected signals (not depicted) returning along or adjacent to line 407 as well.

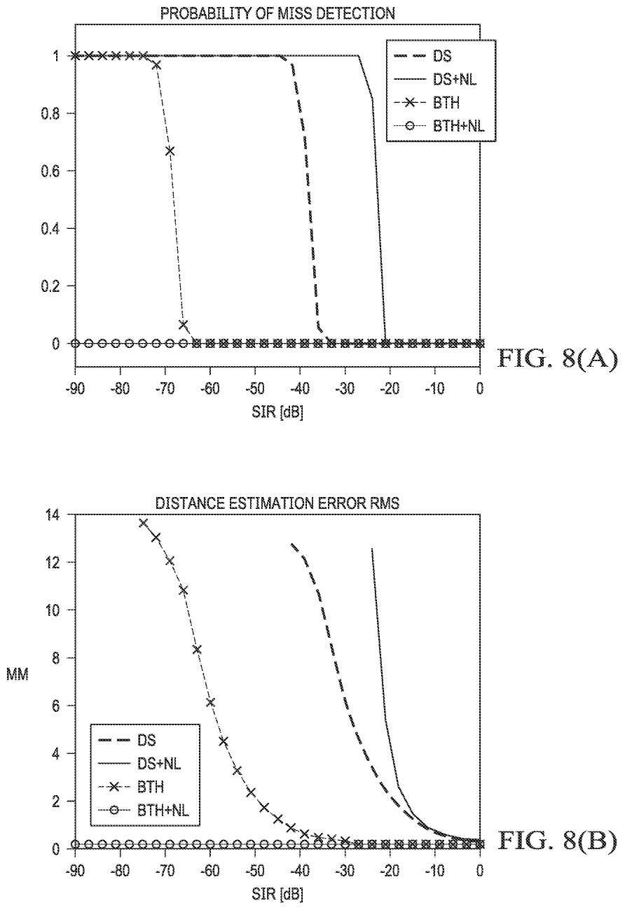

FIG. 8(A) and FIG. 8(B) illustrate simulation results from the simulation testbed shown in FIG. 7 in accordance with various embodiments of the present disclosure. The testbed is tested under four different testing conditions. In a first testing condition, the direct sequence spread spectrum control scheme is applied to the testbed. The first testing condition is denoted as DS as shown in FIG. 8(A) and FIG. 8(B). In a second testing condition, the direct sequence spread spectrum control scheme is applied to the testbed in presence of non-linear distortions. The second testing condition is denoted as DS+NL as shown in FIG. 8(A) and FIG. 8(B). In a third testing condition, the beam-time hopping control scheme is applied to the testbed. The third testing condition is denoted as BTH as shown in FIG. 8(A) and FIG. 8(B). In a fourth testing condition, the beam-time hopping control scheme is applied to the testbed in presence of non-linear distortions. The fourth testing condition is denoted as BTH+NL as shown in FIG. 8(A) and FIG. 8(B).

The curves in FIG. 8(A) are simulation results of probability of miss-detection as a function of signal-to-interference ratio (SIR). The vertical axis represents the probability of miss-detection. The horizontal axis represents SIR. The curves in FIG. 8(B) are simulation results of the root mean square (RMS) of the distance estimation error as a function of SIR. The vertical axis represents the RMS of the distance estimation error. The horizontal axis represents SIR.

In FIG. 8(A), the simulation results of probability of miss-detection under the four testing conditions are illustrated. For the second testing condition (DS+NL), the probability of miss-detection is about zero when SIR is greater than −20 dB. The probability of miss-detection increases up to one when SIR is less than −20 dB. For the first testing condition (DS), the probability of miss-detection is about zero when SIR is greater than −35 dB. The probability of miss-detection increases up to one when SIR is less than −35 dB. For the third testing condition (BTH), the probability of miss-detection is about zero when SIR is greater than −65 dB. The probability of miss-detection increases up to one when SIR is less than −65 dB. For the fourth testing condition (BTH+NL), the probability of miss-detection is about zero when SIR is in range from 0 dB to −90 dB. From the simulation of probability of miss-detection, the fourth testing condition offers the best performance

In FIG. 8(B), the simulation results of the RMS of the distance estimation error under the four testing conditions are illustrated. For the second testing condition (DS+NL), the RMS of the distance estimation error is about zero when SIR is greater than 0 dB. The RMS of the distance estimation error starts to increase up to 13 mm when SIR is less than 0 dB. For the first testing condition (DS), the RMS of the distance estimation error is about zero when SIR is greater than 0 dB. The RMS of the distance estimation error starts to increase up to 13 mm when SIR is less than 0 dB. For the third testing condition (BTH), the RMS of the distance estimation error is about zero when SIR is greater than −30 dB. The RMS of the distance estimation error starts to increase up to 14 mm when SIR is less than −30 dB. For the fourth testing condition (BTH+NL), the RMS of the distance estimation error is about zero when SIR is in range from 0 dB to −90 dB. From the simulation of the RMS of the distance estimation error, the fourth testing condition offers the best performance.

The simulation results in FIG. 8(A) and FIG. 8(B) show the beam-time hopping control scheme significantly improves radar performance even when receiver is not linear. This can be explained by the fact of the pseudo-random codes, which are not completely orthogonal. There is some residual autocorrelation. The beam-time hopping control scheme further improves the time spreading through spreading the signals in the angular domain, which makes the signal more orthogonal, thereby mitigating the interference effect.

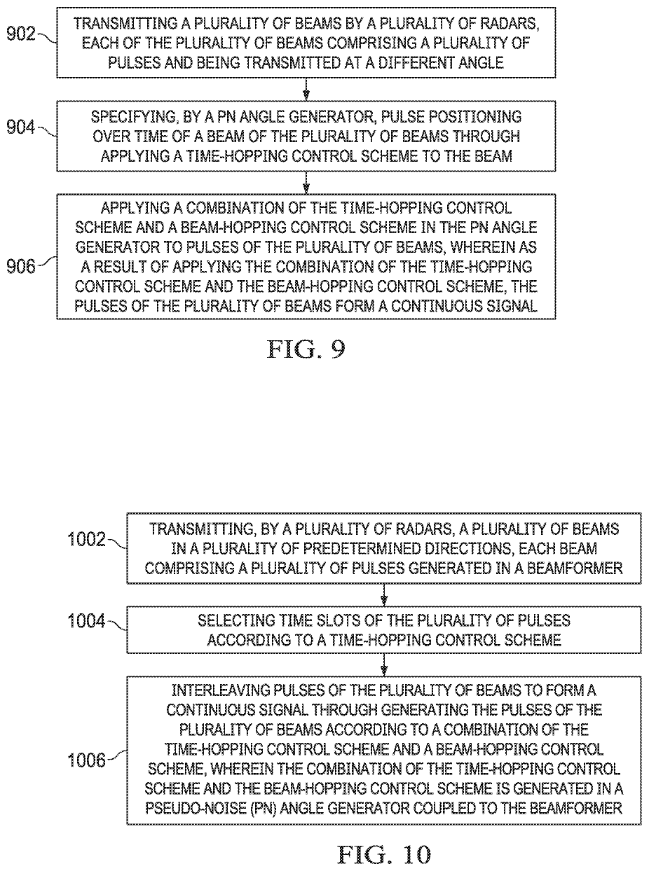

FIG. 9 illustrates a flow chart of a method of applying the beam-time hopping control scheme to the system shown in FIG. 3 in accordance with various embodiments of the present disclosure. This flowchart shown in FIG. 9 is merely an example, which should not unduly limit the scope of the claims. One of ordinary skill in the art would recognize many variations, alternatives, and modifications. For example, various steps illustrated in FIG. 9 may be added, removed, replaced, rearranged and repeated.

At step 902, a plurality of beams is transmitted by a plurality of radars. Each beam of the plurality of beams comprises a plurality of pulses, and each beam is transmitted at a different angle.

At step 904, a time-hopping control scheme is applied to each beam of the plurality of beams The time-hopping control scheme is employed to specify pulse positioning over time of the beam through a pseudo-noise (PN) angle generator.

At step 906, the time-hopping control scheme and a beam-hopping control scheme are combined in the PN angle generator. The combination of the time-hopping control scheme and a beam-hopping control scheme is applied to pulses of the plurality of beams through the beamformer 300 shown in FIG. 3. As a result of applying the combination of the time-hopping control scheme and the beam-hopping control scheme, the pulses of the plurality of beams form a continuous signal.

FIG. 10 illustrates a flow chart of another method of applying the beam-time hopping control scheme to the system shown in FIG. 3 in accordance with various embodiments of the present disclosure. This flowchart shown in FIG. 10 is merely an example, which should not unduly limit the scope of the claims. One of ordinary skill in the art would recognize many variations, alternatives, and modifications. For example, various steps illustrated in FIG. 10 may be added, removed, replaced, rearranged and repeated.

At step 1002, a plurality of beams is transmitted by a plurality of radars. The plurality of beams is transmitted in a plurality of predetermined directions. Each beam of the plurality of beams comprising a plurality of pulses generated in a beamformer.

At step 1004, a time-hopping control scheme is applied to each beam of the plurality of beams Time slots of the plurality of pulses of each beam are selected according to the time-hopping control scheme.

At step 1006, pulses of the plurality of beams are interleaved to form a continuous signal through generating the pulses of the plurality of beams according to a combination of the time-hopping control scheme and a beam-hopping control scheme. The combination of the time-hopping control scheme and the beam-hopping control scheme is generated in a pseudo-noise (PN) angle generator coupled to the beamformer.

The methods shown in FIGS. 9-10 further comprise generating a PN code based on the combination of the time-hopping control scheme and the beam-hopping control scheme, coding the plurality of beams based on the PN code, processing the plurality of beams using an analog front-end, transmitting the plurality of beams processed by the analog front-end through a plurality of radars, receiving a plurality of reflected beams, retrieving directional signals from the plurality of reflected beams, and processing the directional signals in parallel through a plurality of correlators.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. A system comprising:
an analog front-end configured to process a signal to obtain amplified beams, the signal being formed by pulses of a plurality of beams, pulses of each of the plurality of beams being generated according to a time-hopping modulation scheme;
a plurality of radars coupled to the analog front-end, the plurality of radars configured to transmit each of the amplified beams at a different angle, and to receive reflections of the transmitted beams; and
a plurality of correlators coupled to the plurality of radars through the analog front-end, the plurality of correlators being configured to process the reflections of the transmitted beams to obtain proximity measurements.

2. The system of claim 1, further comprising:
a fast Fourier transform (FFT) engine coupled between the analog front-end and the plurality of correlators, the FFT engine being configured to process the reflections of the transmitted beams, and retrieve signals for the plurality of correlators.

3. The system of claim 2, wherein:
the FFT engine is configured to generate a plurality of signals, each of the plurality of signals being fed into a corresponding correlator, proximity measurement information for each angle is derived based on an output signal of the corresponding correlator.

4. The system of claim 1, further comprising:
a beamformer coupled to the analog front-end, the beamformer being configured to generate the plurality of beams; and
a pseudo-noise (PN) angle generator coupled to the beamformer, the PN angle generator being configured to specify pulse positioning over time for each beam.

5. The system of claim 4, wherein:
the PN angle generator is configured to combine the time-hopping modulation scheme with a beam-hopping modulation scheme.

6. The system of claim 5, wherein:
under the time-hopping modulation scheme, each beam of the plurality of beams is a discontinuous signal in a time domain; and
under a combination of the time-hopping modulation scheme and the beam-hopping modulation scheme, signals from the plurality of beams form the signal processed by the analog front-end, wherein the signal processed by the analog front-end is a continuous or substantially continuous signal.

7. The system of claim 6, wherein:
each beam of the plurality of beams comprises a plurality of pulses at pseudo-random time slots; and
under a combination of the time-hopping modulation scheme and the beam-hopping modulation scheme, the pulses from the plurality of beams are combined to form the continuous or substantially continuous signal.

8. The system of claim 1, further comprising:
a plurality of peak-finding units coupled to the plurality of correlators, each of the plurality of peak-finding units being configured to measure a distance between an object and the system based on a delay between a reflection of a transmitted beam and the transmitted beam.

9. A method comprising:
transmitting a plurality of beams by a plurality of radars, each of the plurality of beams comprising a plurality of pulses and being transmitted at a different angle;
specifying, by a pseudo-noise (PN) angle generator, pulse positioning over time of a beam of the plurality of beams through applying a time-hopping control scheme to the beam; and
applying a combination of the time-hopping control scheme and a beam-hopping control scheme in the PN angle generator to pulses of the plurality of beams, wherein as a result of applying the combination of the time-hopping control scheme and the beam-hopping control scheme, the pulses of the plurality of beams form a continuous or substantially continuous signal.

10. The method of claim 9, further comprising:
configuring the PN generator to generate a PN code based on the combination of the time-hopping control scheme and the beam-hopping control scheme; and
coding the plurality of beams based on the PN code.

11. The method of claim 10, further comprising:
receiving reflections of the transmitted beams; and
decoding the reflections of the transmitted beams based on the PN code.

12. The method of claim 9, further comprising:
receiving reflections of the transmitted beams; and
applying an FFT algorithm to the reflections of the transmitted beams, wherein as a result of applying the FFT algorithm, a received signal for each angle is retrieved.

13. The method of claim 12, further comprising:
providing a plurality of correlators configured to receive signals for respective angles; and
processing the signals for the respective angles through the plurality of correlators, wherein the signals for the respective angles are orthogonal to each other.

14. The method of claim 9, wherein applying the time-hopping control scheme comprises:
generating a PN code; and
selecting a time slot for a pulse of the beam in a time frame based on the PN code.

15. The method of claim 9, wherein:
by applying the combination of the time-hopping control scheme and the beam-hopping control scheme, the pulses of the plurality of beams are interleaved to form the continuous or substantially continuous signal.

16. The method of claim 9, further comprising:
processing the continuous or substantially continuous signal using an analog front-end coupled to the plurality of radars.

17. A method comprising:
transmitting, by a plurality of radars, a plurality of beams in a plurality of predetermined directions, each beam comprising a plurality of pulses generated in a beamformer;
selecting time slots of the plurality of pulses according to a time-hopping control scheme; and
interleaving pulses of the plurality of beams to form a continuous or substantially continuous signal by generating the pulses of the plurality of beams according to a combination of the time-hopping control scheme and a beam-hopping control scheme, the combination of the time-hopping control scheme and the beam-hopping control scheme being generated in a pseudo-noise (PN) angle generator coupled to the beamformer.

18. The method of claim 17, further comprising:
generating, by the PN angle generator, a PN code based on the combination of the time-hopping control scheme and the beam-hopping control scheme;
coding the plurality of beams based on the PN code;
processing the plurality of beams using an analog front-end coupled between the beamformer and the plurality of radars to obtain a plurality of beams;
transmitting the plurality of beams processed by the analog front-end through the plurality of radars;
receiving reflections of the transmitted beams through the plurality of radars;
retrieving directional signals from the reflections of the transmitted beams through a fast Fourier transform (FFT) engine coupled to the plurality of radars through the analog front-end; and
processing the directional signals through a plurality of correlators coupled to the FFT engine.

19. The method of claim 18, wherein:
the analog front-end is configured to process the continuous or substantially continuous signal.

20. The method of claim 18, further comprising:
based on a delay between a reflection and a corresponding transmitted beam, measuring a distance between an object and a system comprising the plurality of radars.
